(19) United States
(12) Patent Application Publication
(10) Pub. No.: US 2013/0016739 A1
(43) Pub. Date: Jan. 17, 2013

(54) MULTI-CHANNEL SNIFFER SYSTEM AND METHOD FOR MULTI-CHANNEL SNIFFER SYNCHRONIZATION

(71) Applicants: Nicusor Penisoara, Bucharest (RO); Alin Iulian Lazar, Bucharest (RO)

(72) Inventors: Nicusor Penisoara, Bucharest (RO); Alin Iulian Lazar, Bucharest (RO)

(21) Appl. No.: 13/635,205

(22) PCT Filed: Apr. 8, 2010
(86) PCT No.: PCT/IB10/51526

§ 371 Date: Sep. 14, 2012

(51) Int. Cl. H04L 7/04

(52) U.S. Cl. 370/512

(57) ABSTRACT

A multi-channel sniffer system is provided that includes a reference sniffer comprising a reference clock, secondary sniffers, each having a secondary clock and operable to receive data units from a communication channel, and a synchronization unit connected to the reference sniffer and the secondary sniffers and adapted to switch the reference sniffer and each of the secondary sniffers into a first synchronization mode and to enable a data communication between the reference sniffer and the secondary sniffers. The reference sniffer sends a first delimiting data unit indicating a current reference clock time value to the secondary sniffers when in first synchronization mode. Each of the at least one secondary sniffers is adapted to receive the first delimiting data unit and set a current secondary clock time value of its secondary clock to the current reference clock value.

### FIELD OF THE INVENTION

This invention relates to a multi-channel sniffer system, a method for multi-channel sniffer synchronization and a computer program product.

### BACKGROUND OF THE INVENTION

Data communication networks provide communication channels for communicating data between senders and receivers, wherein sender and receiver apply protocols or sets of rules to communicate with each other across the network. A protocol is a convention or standard that controls or enables the connection, communication, and data transfer between communication endpoints. Especially wireless radio frequency (RF) communication networks allow or require protocols that use multiple RF channels to function, for example IEEE 802.15.4, SynkroRF or ZigBee RF4CE (Radio Frequency for Consumer Electronics) protocols.

During activities like development, testing, analysis and certification multiple sniffers may be used to capture over the air activity, one sniffer per channel, and an apparatus or PC application to display in a user friendly manner the acquired data packets.

A sniffer, or packet analyzer, is a device that can intercept and log traffic passing over a digital network or part of a network and may be implemented in hardware or software. As data streams flow across the network, a sniffer captures packets or data units and, if needed, decodes and analyzes their content or provides it to an analyzing tool for further processing. The captured packets may for instance be analyzed to obtain information about the network or the communication—e.g. to debug the communication or to diagnose network problems. It should be noted that sniffers do not analyze the content of the data units to extract the actual information conveyed by the data units for further processing, although the actual information may be extracted to obtain information about the network or (components involved in) the communication.

It may be necessary that the packets reported by different sniffers be correctly ordered in time. For example, a standard may specify that certain multiple channel operations be performed in a particular order, e.g. transmission on channel 15, then on channel 20, and afterwards on channel 25. In order to avoid packets not being displayed in the correct order when being transmitted at very small time differences, for example in the range of a few milliseconds, on different channels, certain approaches to discerning the order in time of the packets may be applied.

For example, a timestamp for the received packet can be attached to the packet by the sniffer. Usually, a baseband clock is used to get the packet timestamp. The baseband clock may be derived from an on-board crystal oscillator or xtal, that is an electronic circuit that uses the mechanical resonance of a vibrating crystal of piezoelectric material to create an electrical signal with a precise frequency. However, consumer grade xtals' precision may slightly differ (for example +/−10 ppm) between sniffer boards, and the precision of the xtal is replicated by the baseband clock. These differences of the clocks may lead relatively fast to the accumulation of a significant time difference (such as more than 1 ms) between close packets reported by different sniffers.

Another approach may contain the timestamp for the received packet being attached by an embedded computer application, when the packet is received at, e.g., the serial interface of the computer. Here, the timestamp may be affected by the time spent by the packet in the embedded application—delayed by the interrupts processed by the embedded processor. The timestamp can for example be affected by the processing carried out by the computer operating system in the kernel, the priority assigned to the driver and the priority of the port, and packets may sometimes not be delivered to the application “in order”.

However, these two approach have in common that incorrect timestamps may cause that packets received in a short period of time (milliseconds) can not be accurately ordered.

### SUMMARY OF THE INVENTION

The present invention provides a multi-channel sniffer system, a method for multi-channel sniffer synchronization and a computer program product as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 schematically shows a block diagram of an example of an embodiment of a multi-channel sniffer system.

FIG. 2 schematically shows a block diagram of an example of a first embodiment of a method for multi-channel sniffer synchronization.

FIG. 3 schematically shows a diagram of an example of a second embodiment of a method for multi-channel sniffer synchronization.

FIG. 4 schematically shows a diagram of an example of a third embodiment of a method for multi-channel sniffer synchronization.

FIG. 5 schematically shows a diagram of an example of a fourth embodiment of a method for multi-channel sniffer synchronization.

FIG. 6 schematically shows a diagram of an example of a fifth embodiment of a method for multi-channel sniffer synchronization.

FIG. 7 schematically shows a diagram of a clock synchronization error comparison with and without multi-channel sniffer synchronization.

### DETAILED DESCRIPTION OF THE PREFERRED EMBODIMENTS

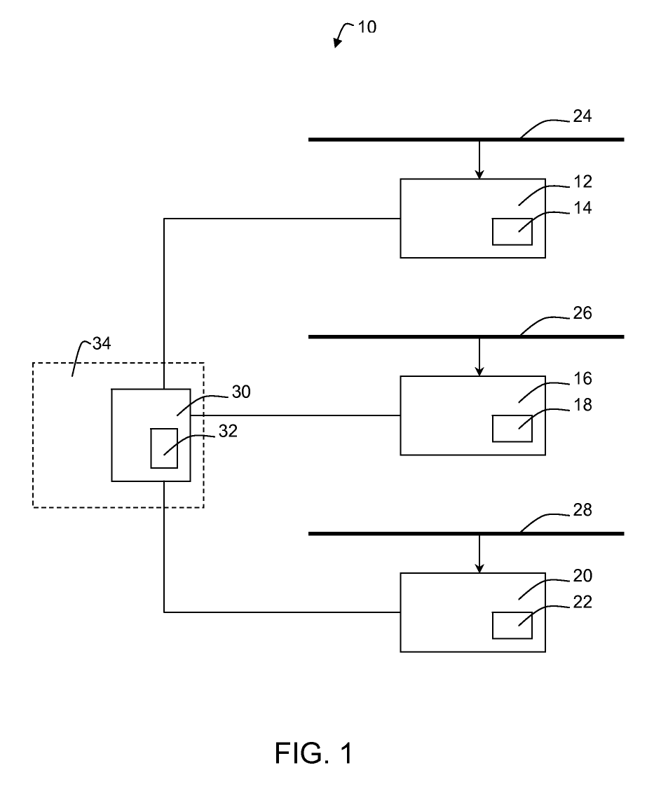

Referring to FIG. 1, a block diagram of an example of an embodiment of a multi-channel sniffer system 10 is shown. A multi-channel sniffer system 10 may comprise a reference sniffer 12 comprising a reference clock 14; one or more secondary sniffers 16, 20, each comprising a secondary clock 18, 22 and operable to receive data units from one of a plurality of communication channels 24, 26, 28; and a synchronization unit 30 connected to the reference sniffer 12 and the one or more secondary sniffers 16, 20 and adapted to switch the reference sniffer 12 and each of the one or more secondary sniffers 16, 20 at least into a first synchronization mode and to enable a data communication between the reference sniffer 12 and the one or more secondary sniffers 16, 20. The reference sniffer 12 may be configured to send a first delimiting data unit indicating a current reference clock time value to the one or more secondary sniffers 16, 20 when in first synchronization mode. Each of the one or more secondary sniffers 16, 20 may be adapted to receive the first delimiting data unit and set a current secondary clock time value of its secondary clock 18, 22 to the current reference clock value.

Multiple sniffers open on different channels may be synchronized without relying on help from the network they sniff. The synchronization may be maintained over time, compensating for clock drift and aging using. The compensation may for example be made on the fly, thus assuring the correct order of packets received over multiple channels in a short time interval.

The shown system may allow for synchronization of all the sniffers involved using one of the sniffers as reference. A reference sniffer may be any of the sniffers belonging to the multi-channel sniffer system selected to serve as reference sniffer. A clock may be any clock signal generating device, for example generating a clock signal derived from a crystal oscillator. The communication channels may be wired or wireless communication channels, such as RF channels.

Enabling data communication between the reference sniffer 12 and the one or more secondary sniffers 16, 20 may for example comprise connecting or moving all sniffers to the same channel or may comprise connecting or moving the reference sniffer 12 to a communication channel having a secondary sniffer 16, 20 attached or subsequently connecting the reference sniffer 12 to each of the channels having a secondary sniffer 16, 20 attached. It should be noted that communication channels may for example be wireless communication channels and moving sniffers from one channel to another may depend on the channel setup. For example, a frequency multiplexing system may require the sniffer to change its target frequency in order to sniff a different channel, whereas time division multiplex may require a change in offset time before accessing a channel or code division multiplexing may require the sniffer to change the chip code.

When not switched to first synchronization mode, the sniffers may for example be in a normal mode of operation wherein data packets transmitted on their particular channel may for example be captured and analyzed.

The term “each” secondary sniffer may not be understood as inhibiting a presence of other sniffers. It may exclude other sniffers from being considered part of the presented multi-channel sniffer system.

The first delimiting data unit or packet may for example indicate the current reference clock time value or timestamp, that is the timestamp of the reference sniffer upon sending the delimiting data unit to the one or more secondary sniffers 16, 20, by attaching the timestamp as payload to the delimiting data unit.

In an embodiment, the current reference clock time value may be indicated to the one or more secondary sniffers without attaching it to the delimiting data unit as payload, just by receiving the first delimiting data unit itself. The reference sniffer may be adapted to reset the reference sniffer clock upon sending the first delimiting data unit and each of the one or more secondary sniffers may be adapted to reset its secondary clock upon reception of the first delimiting data unit. Hence, with pre-defined reset values, for example zero, transmission of the actual reference clock time value may not be required. This embodiment may comprise the system being adapted to move all sniffers to the same channel. Only one first delimiting data unit may be transferred from the reference sniffer to the one or more secondary sniffers for setting all clock values to a defined initial synchronization time such as zero time.

In another embodiment of the multi-channel sniffer system 10 the synchronization unit 30 may be adapted to selectively switch one of the one or more secondary sniffers 16, 20 into the first synchronization mode and enable the communication between the reference sniffer and the selected one of the one or more secondary sniffers. Here, the reference clock time value may be indicated to the receiving secondary sniffer by sending this timestamp for example as payload of the first delimiting data units. No reset may be applied to the reference clock 14. This embodiment may comprise moving the reference sniffer 12 on every channel sniffed by a secondary sniffer 16, 20, setting the sniffers in first synchronization mode, using the first mark packet or first delimiting data unit to set the same clock values on the receiving secondary sniffer as on the reference sniffer 12. In this embodiment of the system 10, the reference sniffer 12 may for example be used for synchronization purposes only and may be an additional sniffer on top of the secondary sniffer used for monitoring a certain number of channels. Secondary sniffer may remain connected to their dedicated channel and all channels may be continuously monitored.

The synchronization unit 30 may be adapted to switch the reference sniffer 12 into a second synchronization mode and to enable a data communication between the reference sniffer 12 and the one or more secondary sniffers 16, 20. The reference sniffer 12 may be configured to send a second delimiting data unit indicating a current reference clock time value to the one or more secondary sniffers 16, 20 when in second synchronization mode. Each of the one or more secondary sniffers 16, 20 may be adapted to receive the second delimiting data unit and provide a current secondary clock time value upon reception of the second delimiting data unit and the reference clock value to the synchronization unit 30. The synchronization unit 30 may comprise a processing module 32 for determining a difference between the reference clock value and the secondary clock value. In another embodiment, the secondary sniffer may comprise a processing device for determining timestamp differences and may either be adapted to provide these values to the synchronization unit 30 or may be adapted to compensate for timestamp differences.

When in second synchronization mode, the reference sniffer 10 may be configured to send in regular time intervals within a pre-determined period of time the second delimiting data unit.

A regular time interval may for example be 5 seconds and a pre-determined period of time may for example be 30 seconds. This may allow for determining within the pre-determined period of time a plurality of difference values and may allow for reliable clock drift estimation.

The synchronization unit 30 may be adapted to selectively enable communication between the reference sniffer 12 and a selected one of the one or more secondary sniffers 16, 20.

It should be noted that it is possible that secondary sniffers 16, 20 are switched into the second synchronization mode. Second delimiting data units may be received and analyzed during normal operation mode, similar to other packets captured on the sniffed channel.

For achieving long term drift compensation, the multi-channel sniffer system may be configured to perform the synchronization procedure at longer time intervals, during determined silence periods, and using a compensation rule. The synchronization unit 30 may be operable to determine a compensation rule for one or more of the secondary sniffer clocks. For example detected clock differences may be evaluated and forthcoming clock drift may be estimated and a compensation rule may be derived and updated, for example regularly or during the determined silence periods.

The multi-channel sniffer system 10 may comprise a protocol analyzer device 34, which comprises said synchronization unit 30, adapted to receive sniffed data unit information from a plurality of the sniffers 12, 16, 20 and apply the compensation rule to compensate for clock drift of data units sniffed by one or more of said secondary sniffers. This may allow for prediction of the clock drift and continuous compensation for all received packets from every sniffer, except the reference sniffer.

The protocol analyzer may for example be comprised in a computer, for example as a PC application, or may itself comprise a processing device, a memory device and a display device.

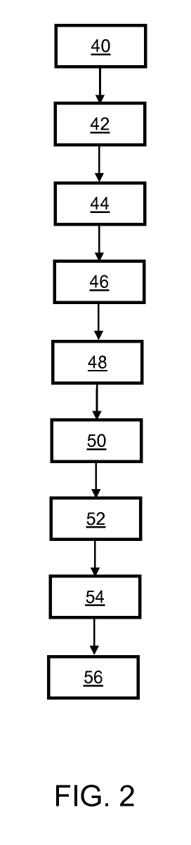

Referring now also to FIG. 2, a diagram of an example of a first embodiment of a method for multi-channel sniffer synchronization is shown. The method illustrated in FIGS. 2, 3, 4, 5 and 6 allows implementing the advantages and characteristics of the described multi-channel sniffer system as part of a method for multi-channel sniffer synchronization.

The shown method for sniffer synchronization in a multi-channel sniffer system comprising a reference sniffer comprising a reference clock, one or more secondary sniffers, each comprising a secondary clock and operable to receive data units from one of a plurality of communication channels, and a synchronization unit connected to the reference sniffer. The one or more secondary sniffers may comprise switching 40 the reference sniffer and each of the one or more secondary sniffers at least into a first synchronization mode; enabling 42 a data communication between the reference sniffer and the one or more secondary sniffers; sending 44 a first delimiting data unit indicating a current reference clock time value from the reference sniffer to the one or more secondary sniffers when in first synchronization mode; and each of the one or more secondary sniffers receiving 46 the first delimiting data unit and setting a current secondary clock time value of its secondary clock to the current reference clock value.

Further, the method may comprise switching 48 the reference sniffer into a second synchronization mode; enabling 50 a data communication between the reference sniffer and the one or more secondary sniffers; sending 52 a second delimiting data unit indicating a current reference clock time value from the reference sniffer to the one or more secondary sniffers when in second synchronization mode; each of the one or more secondary sniffers receiving 54 the second delimiting data unit and providing a current secondary clock time value upon reception of the second delimiting data unit and the reference clock value to the synchronization unit; and determining 56 a difference between the reference clock value and the secondary clock value.

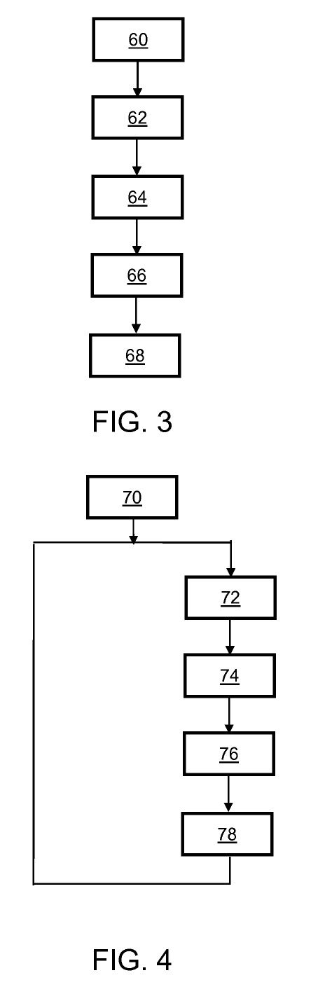

Referring now also to FIG. 3, a diagram of an example of a second embodiment of a method for multi-channel sniffer synchronization is shown. All sniffers may be moved 60 on the same channel and all sniffers may be set 62 in a first synchronization mode. A first delimiting data unit or first mark packet may be sent 64 using the reference sniffer and the reference sniffer may reset 66 its reference sniffer clock upon sending the first delimiting data unit. Upon receiving the first delimiting data unit all receiving, that is all secondary sniffers may reset 68 their clock. This embodiment may allow for very fast initial synchronization, especially for systems sniffing a great number of channels.

Referring now also to FIG. 4, a diagram of an example of a third embodiment of a method for multi-channel sniffer synchronization is shown. Here, for every sniffed channel 70 the method may comprise performing the following steps: The reference sniffer may be moved to a channel being sniffed by a secondary sniffer. The receiving secondary sniffer may also be set 74 into first synchronization mode and the reference sniffer may be used for sending 76 the first delimiting data unit. The secondary sniffer may receive the first delimiting data unit and the indicated reference sniffer clock value may be set 78 as the receiving secondary sniffer clock value.

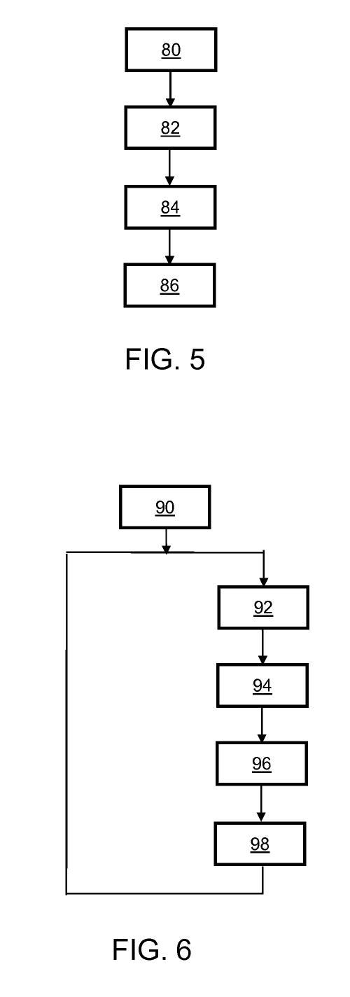

Referring now also to FIG. 5, a diagram of an example of a fourth embodiment of a method for multi-channel sniffer synchronization is shown. Here, the clock drift compensation is illustrated. All sniffers may be moved 80 to the same channel and the reference sniffer may be set 82 into a second synchronization mode. From the reference sniffer, a second delimiting data unit or packet containing the reference sniffer clock time value may be sent 84. The difference between the timestamp of the second delimiting data unit received by a secondary sniffer and the reference sniffer clock value may then be used 86 to estimate clock drift. For example, the synchronization unit or a PC application comprising or being connected to the synchronization unit may use the difference between the receiving sniffer time and the reference time to determine and update a compensation law for that particular sniffer.

Referring now also to FIG. 6, a diagram of an example of a fifth embodiment of a method for multi-channel sniffer synchronization is shown, also illustrating clock drift compensation. Here, for 90 every channel sniffed by a secondary sniffer the method may comprise performing the following steps: The reference sniffer may be moved 92 to a channel sniffed by a secondary sniffer and the reference sniffer may be set 94 into a second synchronization mode. The reference sniffer may send 96 a second delimiting data unit or second mark packet comprising the current reference sniffer clock time value. The secondary sniffer receiving this second delimiting data unit may then use 98 the reference sniffer clock time value to estimate the drift between reference clock and secondary sniffer clock. The difference between the receiving sniffer time and the reference time may be used to determine and update a compensation law for the particular sniffer.

The presented system and method may for example be applied in protocols development, testing, analysis, and certification of devices for multi-channel systems, for example multi-channel protocol analyzer devices or gateway or bridge devices. A multi-channel protocol analyzer may allow reliable synchronization of different listening units in order to present the user with accurate sequence of over the air messages. Gateway/bridge devices may be used for pulling together single or multiple wireless networks into a single back hole as well as advanced routing and priority handling algorithms may be supported. As another example, the presented system may allow for advanced positioning algorithms: For asset tracking applications, having multiple listeners monitoring a single network (i.e. RF channel) synchronization may provide reliable information that a host processor may use to triangulate the source and develop an estimate of relative position of the source device.

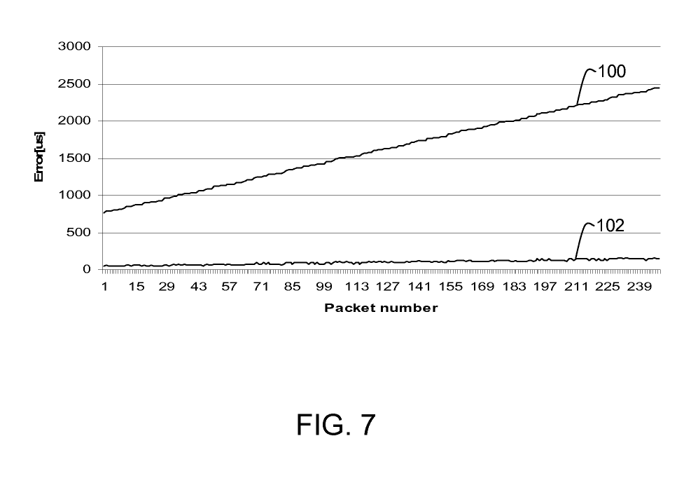

Referring now to FIG. 7, a diagram of an example of a clock synchronization error comparison with and without multi-channel sniffer synchronization is illustrated. As an example, the graph presents the error in microseconds, i.e. the difference in the times for the same packet received by two un-synchronized sniffers and two synchronized sniffers 102 versus the number of transmitted packets.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The invention may also be implemented in a computer program for running on a computer system, at least including code portions for performing steps of a method according to the invention when run on a programmable apparatus, such as a computer system or enabling a programmable apparatus to perform functions of a device or system according to the invention. For example, the synchronization unit or the protocol analyzer may be implemented as a computer program such as a sniffer test tool. This may for example allow usage of inexpensive resources available on a programmable apparatus such as a PC (personal computer). Time compensation for the synchronized sniffers may be carried out on a PC application. The presented system may allow for undertaking reliable, non-intrusive, investigation of a running multi-channel network.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, the synchronization unit 30 may be merged with the reference sniffer device 10.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. For example, synchronization unit and sniffer devices may be implemented within the same device. Alternatively, the examples may be implemented as any number of separate integrated circuits or separate devices interconnected with each other in a suitable manner. For example, each sniffer and the synchronization unit may be implemented as separate devices

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While the principles of the invention have been described above in connection with specific apparatus, it is to be clearly understood that this description is made only by way of example and not as a limitation on the scope of the invention.

1. A multi-channel sniffer system, comprising:
a reference sniffer comprising a reference clock;
at least one secondary sniffer, comprising a secondary clock, wherein
said reference sniffer and said secondary sniffer being connectable to a communication channel for receiving, in at least a sniffing mode, data units from a respective communication channel; and
a synchronization unit connected to said reference sniffer and said at least one secondary sniffer and adapted to
switch said reference sniffer and secondary sniffer at least into a first synchronization mode, and
enable in at least said first synchronization mode a data communication between said reference sniffer and said at least one secondary sniffers;
wherein,
said reference sniffer is configured to send a first delimiting data unit indicating a current reference clock time value to said at least one secondary sniffers when in first synchronization mode, and
each of said at least one secondary sniffers are adapted to receive said first delimiting data unit and set a current secondary clock time value of its secondary clock to said current reference clock value.

2. The multi-channel sniffer system as claimed in claim 1, wherein said reference sniffer is adapted to reset said reference sniffer clock upon said sending said first delimiting data unit and each of said at least one secondary sniffers is adapted to reset its secondary clock upon reception of said first delimiting data unit.

3. The multi-channel sniffer system as claimed in claim 1, wherein said synchronization unit is adapted to selectively switch one of said at least one secondary sniffers into said first synchronization mode and enable said communication between said reference sniffer and said selected one of said at least one secondary sniffers.

4. The multi-channel sniffer system as claimed in claim 1, wherein
said synchronization unit is adapted to switch said reference sniffer into a second synchronization mode and to enable a data communication between said reference sniffer and said at least one secondary sniffer;
said reference sniffer is configured to send a second delimiting data unit indicating a current reference clock time value to said at least one secondary sniffer when in second synchronization mode;
said at least one secondary sniffer is adapted to receive said second delimiting data unit and provide a current secondary clock time value upon reception of said second delimiting data unit and said reference clock value to said synchronization unit; and
said synchronization unit comprises a processing module for determining a difference between said reference clock value and said secondary clock value.

5. The multi-channel sniffer system as claimed in claim 4, wherein said reference sniffer is configured to send in regular time intervals within a pre-determined period of time said second delimiting data unit.

6. The multi-channel sniffer system as claimed in claim 4, wherein said synchronization unit is adapted to selectively enable communication between said reference sniffer and a selected one of said at least one secondary sniffers.

7. The multi-channel sniffer system as claimed in claim 4, wherein said synchronization unit is operable to determine a compensation rule for at least one of said secondary sniffer clocks.

8. The multi-channel sniffer system as claimed in claim 7 further comprising:
a protocol analyzer device having said synchronization unit, wherein the protocol analyzer device is adapted to
receive sniffed data unit information from a plurality of said sniffers, and
apply said compensation rule to compensate for clock drift of data units sniffed by at least one of said secondary sniffers.

9. A method for sniffer synchronization in a multi-channel sniffer system, the system comprising a reference sniffer, at least one secondary sniffer and, said reference sniffer and said secondary sniffer being connectable to a respective communication channel, and a synchronization unit connected to said reference sniffer and said at least one secondary sniffers, said method comprising:
switching said reference sniffer and each of said at least one secondary sniffers at least into a first synchronization mode, wherein
said reference sniffer comprises a reference clock, and
said at least one secondary sniffer each comprises a secondary clock;
sending a first delimiting data unit comprising a current reference clock time value from said reference sniffer to said at least one secondary sniffer when in first synchronization mode; and
receiving said first delimiting data unit, by said at least one secondary sniffer, and setting a current secondary clock time value of a secondary clock of said at least one secondary sniffer to said current reference clock value.

10. The method as claimed in claim 9, comprising
switching said reference sniffer into a second synchronization mode;
sending a second delimiting data unit comprising a second current reference clock time value from said reference sniffer to said at least one secondary sniffers when in second synchronization mode;
receiving said second delimiting data unit, by each of said at least one secondary sniffers, and providing a current secondary clock time value upon reception of said second delimiting data unit and said reference clock value to said synchronization unit; and
determining a difference between said reference clock value and said secondary clock value.

11. (canceled)

12. A method for multi-channel sniffer synchronization comprising:
transmitting a first signal by a reference sniffer, wherein
the multi-channel sniffer comprises the reference sniffer and one or more secondary sniffers, and
the reference sniffer is coupled to one or more secondary sniffers by a communication channel;
receiving the first signal by a subset of the one or more secondary sniffers, wherein the subset of the one or more secondary sniffers are configured in a first synchronization mode; and
setting a clock of each of the subset of the one or more secondary sniffers in response to said receiving the first signal.

13. The method of claim 12 further comprising:
moving the reference sniffer and the one or more secondary sniffers to the communication channel prior to said transmitting the first signal.

14. The method of claim 12 further comprising:
moving the reference sniffer to the communication channel to the communication channel prior to said transmitting the first signal, wherein the subset of the one or more secondary sniffers are coupled to the communication channel prior to said moving the reference sniffer.

15. The method of claim 12 wherein the first signal is one of a first delimiting data unit or a first mark packet.

16. The method of claim 12 further comprising:
resetting a clock of the reference sniffer subsequent to transmitting the first signal by the reference sniffer.

17. The method of claim 12 wherein said setting the clock of each of the subset of the one or more secondary sniffers comprises resetting the clock of each of the subset of the one or more secondary sniffers.

18. The method of claim 12 wherein said setting the clock of each of the subset of the one or more secondary sniffers comprises setting the clock of each of the subset of the one or more secondary sniffers to a reference clock value comprised in the first signal.
